(19) United States
(12) Patent Application Publication
(10) Pub. No.: US 2021/0159609 A1
(43) Pub. Date: May 27, 2021

(54) CAPACITIVE-COUPLED COMB-LINE MICROSTRIP ARRAY ANTENNA

(71) Applicant: ELECTRONICS AND TELECOMMUNICATIONS RESEARCH INSTITUTE, Daejeon (KR)

(72) Inventor: Jae Ho LEE, Suwon (KR)

(21) Appl. No.: 17/100,605

(22) Filed: Nov. 20, 2020

(30) Foreign Application Priority Data
Nov. 21, 2019 (KR) 10-2019-0150136
Nov. 19, 2020 (KR) 10-2020-0155416

(51) Int. Cl. H01Q 21/06; H01Q 9/04; H01Q 3/30

(52) U.S. Cl. CPC H01Q 21/065; H01Q 3/30; H01Q 9/0457

(57) ABSTRACT

The present invention relates to a capacitively-coupled comb-line microstrip array antenna. The capacitively-coupled comb-line microstrip array antenna includes a dielectric substrate, a feed line formed on the dielectric substrate in a length direction thereof, and microstrip patches vertically formed with a gap of a certain interval from the feed line.

### CROSS-REFERENCE TO RELATED APPLICATION

This application claims priority to and the benefit of Korean Patent Application No. 10-2019-0150136, filed on Nov. 21, 2019 and Korean Patent Application No. 10-2020-0155416, filed on Nov. 19, 2020, the disclosure of which is incorporated herein by reference in its entirety.

### BACKGROUND

### 1. Field of the Invention

The present invention relates to a microstrip array antenna, and more particularly, to an array antenna using a rectangular microstrip patch as a radiating element.

### 2. Discussion of Related Art

Microstrip antennas or microstrip patch array antennas may have a low profile, may be easily attached to not only planar surfaces but also to non-planar surfaces, may be simply designed, may be manufactured at a low cost using printed circuit technologies, may be designed together with monolithic microwave integrated circuits, and may have excellent mechanical strength, and thus may be applied in various fields.

Such a patch antenna is used as a single radiating element and is also widely used in an array form so as to increase an antenna gain or control a radiation pattern.

As a feeding method of the patch array antenna, a series feeding or corporate feeding method is mainly used, and each feeding method has advantages and disadvantages.

In series-fed patch array antennas, a plurality of microstrip patch-type radiating elements are disposed in one direction and are connected to each other through a series-fed line.

A phase of a current input to the radiating element through the series-fed line may be adjusted to adjust an inclination of a beam emitted from the radiating element, that is, a radiation beam. The size of the radiating element and the distance between the radiating elements may be adjusted to synthesize a beam.

In general, when the beam direction is formed toward the front of the antenna, in order to feed currents having an equal phase to the radiating elements, the radiating elements are disposed such that the distance between the radiating elements is one wavelength (λ_{g}) in an operating frequency band.

Thus, in the case of an antenna that requires a high directivity gain, since the number of elements should be increased, the length of an entire array is increased.

In the conventional series-fed array antenna (Korean Patent Registration No. 10-1664389), when patch radiating elements in a series-fed type are arranged, the number of the radiating elements should be increased when a high directivity gain is required, thereby resulting in an increase in length of an entire array.

In this case, when the length of the array is increased, due to a long line effect, a beam tilting in the front direction of an antenna occurs at frequencies other than a design frequency.

In the conventional comb-line microstrip patch array antenna (paper 1), a ground plane is formed below a dielectric substrate, and a straight microstrip feed line and microstrip patches which are radiating elements are disposed on the dielectric substrate to constitute an array.

However, in the conventional comb-line microstrip patch array antenna, the microstrip feed line and the microstrip patches which are the radiating elements are electrically connected, and a radiation conductance of the radiating element is adjusted with a width of the microstrip patch which is the radiating element.

In order to design an array antenna having a low side lobe level radiation pattern in an antenna having such a linear array structure, since edge radiating elements positioned at an input side and an end side of the antenna feed part have a low radiation conductance value, and an element positioned at a center thereof should have a relatively high radiation conductance value, a microstrip patch at the center is wide, and microstrip patches become gradually thinner toward the edge.

However, when the microstrip patch is wide, since a current on the patch has a component in a width direction as well as a component in a length direction, a radiated electromagnetic wave has a problem in that a cross polarization component thereof is increased and a side lobe level thereof is also increased.

In addition, in the wide microstrip patch, there is a problem in that the position of the radiating element should be adjusted because an effective radiating point is changed.

Therefore, in the conventional comb-line microstrip patch array antenna, there is a limitation in lowering a side lobe level, and there is a problem in that the design difficulty is increased.

### SUMMARY OF THE INVENTION

The present invention is directed to providing a capacitively-coupled comb-line microstrip array antenna in which radiating conductance of a radiating element is adjusted with a gap of a microstrip patch and a feed line for design a low side lobe level pattern in a conventional comb-line microstrip patch array antenna, thereby preventing cross polarization generated in an antenna and solving a difficulty in designing a low side lobe level.

Objects of the present invention are not limited to the above-described object, and other objects that have not been described above will be apparent from the following description.

According to an aspect of the present invention, a capacitively-coupled comb-line microstrip array antenna includes a dielectric substrate, a feed line formed on the dielectric substrate in a length direction thereof, and microstrip patches vertically formed with a gap of a certain interval from the feed line.

The gap (G) between the feed line and the microstrip patch may be determined according to a length of the microstrip patch in a resonance state.

According to another aspect of the present invention, a capacitively-coupled comb-line microstrip array antenna includes a dielectric substrate, a feed line formed on the dielectric substrate in a length direction thereof, a radiating element array module formed by microstrip patches vertically formed with a gap (G) from the feed line being arranged at certain intervals at one side of the feed line, and a ground plane formed on a lower surface of the dielectric substrate.

The microstrip patches may have rectangular shapes having the same width.

An interval between the microstrip patches formed in the radiating element array module may be a wavelength (λ_{g}) of the feed line.

According to still another aspect of the present invention, the capacitively-coupled comb-line microstrip array antenna may further include a radiating element array module formed by microstrip patches vertically formed with a certain distance from the feed line being arranged at certain intervals at the other side of the feed line.

The microstrip patch formed in the radiating element array module formed at one side of the feed line and the microstrip patch formed in the radiating element array module formed at the other side thereof may be formed to include open stubs with the feed line interposed therebetween.

The interval between the microstrip patches formed in the radiating element array module may be a half-wavelength (λ_{g}/2) of the feed line.

A length of the microstrip patch may be determined by a length of the microstrip patch in a resonance state based on the gap (G) between the feed line and the microstrip patch.

A plurality of radiating element array modules identical to the radiating element array module may be formed in parallel.

The gap (G) between the microstrip patch and the feed line may correspond to a weighting distribution.

A direction of a beam may be adjusted by adjusting a phase excited in the microstrip patch which is each radiating element.

### BRIEF DESCRIPTION OF THE DRAWINGS

FIG. 1 is a diagram for describing a capacitively-coupled comb-line microstrip antenna according to one embodiment of the present invention.

FIG. 2 is an equivalent circuit diagram of the capacitively-coupled comb-line microstrip antenna according to one embodiment of the present invention.

FIG. 3 is a diagram for describing a capacitively-coupled comb-line microstrip array antenna according to another embodiment of the present invention.

FIG. 4 is a diagram for describing a capacitively-coupled comb-line microstrip array antenna according to still another embodiment of the present invention.

FIG. 5 illustrates an equivalent circuit of the capacitively-coupled comb-line microstrip array antenna according to still another embodiment of the present invention.

FIG. 6 illustrates an equivalent circuit when microstrip patches are in a resonance state in which lengths of the microstrip patches (231) are adjusted to cancel susceptance, which is an imaginary part of admittance, and leave only conductance which is a real part thereof in the capacitively-coupled comb-line microstrip array antenna according to another embodiment of the present invention.

FIG. 7 illustrates a capacitively-coupled comb-line microstrip patch array antenna according to yet another embodiment of the present invention, which is designed to implement the same performance as a conventional capacitively-coupled comb-line microstrip patch array antenna.

FIG. 8 illustrates a 1×18 capacitively-coupled comb-line microstrip patch designed using one radiating element array module (230) of a capacitively-coupled comb-line microstrip array antenna according to yet another embodiment of the present invention.

FIG. 9 illustrates a 4×18 capacitively-coupled comb-line microstrip patch in which four radiating element array modules of a capacitively-coupled comb-line microstrip array antenna are combined in parallel according to yet another embodiment of the present invention.

FIG. 10 is a graph showing a reflection coefficient of the 1×18 capacitively-coupled comb-line microstrip patch array antenna according to yet another embodiment of the present invention.

FIG. 11 is a graph showing a reflection coefficient of the 4×18 capacitively-coupled comb-line microstrip patch array antenna according to yet another embodiment of the present invention.

FIG. 12 shows simulated values and measurement values of a radiation pattern of the 1×18 capacitively-coupled comb-line microstrip patch array antenna and is a graph showing simulated values and measurement values of a radiation pattern on a vertical plane (y-z plane) at a frequency of 79 GHz.

FIG. 13 shows simulated values and measurement values of a radiation pattern of the 1×18 capacitively-coupled comb-line microstrip patch array antenna and is a graph showing simulated values and measurement values of a radiation pattern on a horizontal plane (x-z plane) at a frequency of 79 GHz.

FIG. 14 shows simulated values and measurement values of a radiation pattern of the 4×18 capacitively-coupled comb-line microstrip patch array antenna and is a graph showing simulated values and measurement values of a radiation pattern on a vertical plane (y-z plane) at a frequency of 79 GHz.

FIG. 15 shows simulated values and measurement values of a radiation pattern of the 4×18 capacitively-coupled comb-line microstrip patch array antenna and is a graph showing simulated values and measurement values of a radiation pattern on a horizontal plane (x-z plane) at a frequency of 79 GHz.

### DETAILED DESCRIPTION OF EXEMPLARY EMBODIMENTS

The advantages and features of the present disclosure and methods for accomplishing the same will be more clearly understood from embodiments to be described in detail below with reference to the accompanying drawings. However, the present invention is not limited to the following embodiments but may be implemented in various different forms. Rather, these embodiments are provided only to complete the disclosure of the present invention and to allow those skilled in the art to understand the category of the present invention. The present invention is defined by the category of the claims. Meanwhile, terms used in this specification are to describe the embodiments and are not intended to limit the present invention. As used herein, singular expressions, unless defined otherwise in contexts, include plural expressions. It will be further understood that the terms “comprises,” “comprising,” “includes,” and/or “including,” if used herein, specify the presence of stated components, steps, operations, and/or elements, but do not preclude the presence or addition of one or more other components, steps, operations, and/or elements.

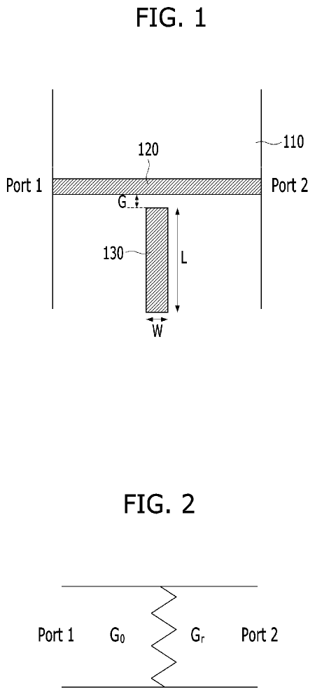

FIG. 1 is a diagram for describing a capacitively-coupled comb-line microstrip antenna according to one embodiment of the present invention, and FIG. 2 is an equivalent circuit diagram of the capacitively-coupled comb-line microstrip antenna according to one embodiment of the present invention.

As shown in FIG. 1, the capacitively-coupled comb-line microstrip antenna according to one embodiment of the present invention includes a dielectric substrate 110, a feed line 120, and radiating elements 130.

The dielectric substrate 110 has a quadrangular plate shape having a permittivity (εᵣ) of constant value.

The feed line 120 is formed on the dielectric substrate 110 in a length direction thereof.

The radiating element 130 is vertically formed with a gap G of a certain interval from the feed line 120.

In one embodiment of the present invention, radiation conductance (Gᵣ) of the radiating element 130 is calculated using a length of the radiating element 130 in a resonance state based on the gap G between the feed line 120 and the radiating element 130.

That is, as shown in FIG. 2, radiation conductance of the capacitively-coupled comb-line microstrip antenna according to one embodiment of the present invention may be calculated through Equation 1 below.

$$\frac{{G}_{r}}{{G}_{0}} = \frac{2 ( 1 \vert {S}_{21} )}{{S}_{21}} \qquad [ Equation 1 ]$$

Here, Gᵣ refers to radiation conductance, G₀ refers to characteristic impedance of a feed line, and S₂₁ refers to a value of power for transferring from a in port to a out port.

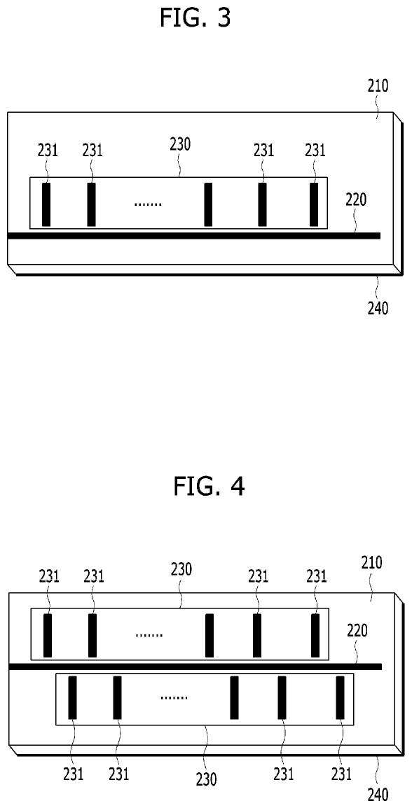

FIG. 3 is a diagram for describing a capacitively-coupled comb-line microstrip array antenna according to another embodiment of the present invention.

As shown in FIG. 3, the capacitively-coupled comb-line microstrip array antenna according to another embodiment of the present invention includes a dielectric substrate 210, a feed line 220, a radiating element array module 230, and a ground plane 240.

The dielectric substrate 210 has a flat plate shape having a permittivity (εᵣ) of constant value.

The feed line 220 is formed on the dielectric substrate 210 in a length direction thereof and is made of the same material as microstrip patches 231.

The radiating element array module 230 is formed by the microstrip patches 231 vertically formed with a gap G from the feed line 220 being arranged at certain intervals at one side of the feed line 220. In this case, the microstrip patch 231 may form the gap G with the feed line 220 so as to correspond to radiation conductance (Gᵣ) to be formed, and thus, a desired capacitively-coupled comb-line array antenna may be designed. Here, the microstrip patches 231 are not connected directly to the feed line 220 and are disposed with the gap from the feed line 220 to resonate through capacitive coupling with the feed line 220. The microstrip patches 231 may have rectangular shapes with the same width.

The interval between the microstrip patches 231 formed in the radiating element array module 230 may be a wavelength (λ_{g}) of the feed line 220.

The microstrip patch 231 may be formed to have a length of the microstrip patch 231 in a resonance state based on a length of the gap G.

The ground plane 240 is formed on a lower surface of the dielectric substrate 210.

FIG. 4 is a diagram for describing a capacitively-coupled comb-line microstrip array antenna according to still another embodiment of the present invention.

As shown in FIG. 4, the capacitively-coupled comb-line microstrip array antenna according to still another embodiment of the present invention further includes a radiating element array module 230 formed by microstrip patches 231 vertically formed with a predetermined distance from the feed line 220 being arranged at certain intervals at the other side of the feed line 220 in addition to the configuration of another embodiment of the present invention.

Here, open stubs may be provided to form an interval s between the radiating element 130 formed in the radiating element array module 230 formed at one side of the feed line 220 and the radiating element 130 formed in the radiating element array module 230 formed at the other side of the feed line 220.

An interval between the radiating elements 130 formed in the radiating element array module 230 may be a half-wavelength (λ_{g}/2) of the feed line 220.

Meanwhile, in still another embodiment of the present invention, a direction of a beam may be adjusted by adjusting a phase excited in the microstrip patch 231 which is each radiating element. That is, when it is necessary for the antenna to form a beam in a desired direction, the phase excited in the microstrip patch 231, which is each radiating element, should be adjusted. Therefore, the interval s between the microstrip patches may be changed to adjust the direction of the beam.

As described above, in the case of the capacitively-coupled comb-line microstrip array antenna according to still another embodiment of the present invention, in order to apply power to the antenna by connecting the antenna to a chip or a transmission line, the feed line 220 at an input portion of the antenna may be connected directly to the chip or changed into various types of transition portions. In addition, if necessary, a matching circuit such as a quarter-wavelength transformer may be added for impedance matching.

Meanwhile, the feed line 220 may be formed in the form of a microstrip line. For easy design and manufacturing, according to a dielectric constant (24 of the dielectric substrate 210, a width of the microstrip line of the feed line 220 may be changed in order for the feed line 220 to have various characteristic impedances (G₀).

In order to feed the microstrip patches 231, i.e., the radiating elements at an equal phase, the open stubs are positioned at both sides of the feed line 220 such that the interval s between the open stubs is a half-wavelength (λ_{g}/2) of the microstrip feed line 220.

Meanwhile, in still another embodiment of the present invention, before an antenna having the same performance as a conventional comb-line microstrip patch array antenna is designed, after the gap G between the microstrip patches 231 to be arranged is determined, each of lengths of the microstrip patches 231 entering a resonance state is detected based on the gap G.

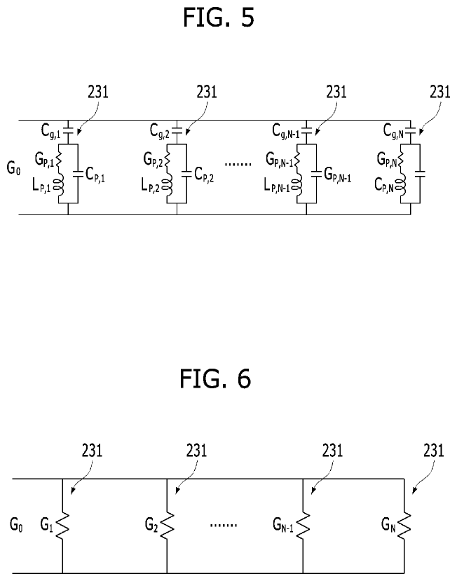

FIG. 5 illustrates an equivalent circuit of the capacitively-coupled comb-line microstrip array antenna according to still another embodiment of the present invention. FIG. 6 illustrates an equivalent circuit when the microstrip patches 231 are in a resonance state in which the lengths of the microstrip patches 231 are adjusted to cancel susceptance, which is an imaginary part of admittance, and leave only conductance, which is a real part thereof, in the capacitively-coupled comb-line microstrip array antenna according to still another embodiment of the present invention.

As shown in FIG. 5, in the capacitively-coupled comb-line microstrip array antenna according to still another embodiment of the present invention, admittance of each microstrip patch 231 may be represented by parasitic capacitance (C_{g}) due to the gap G between the microstrip feed line 220 and the microstrip patch 231, conductance and parasitic inductance (Lₚ) due to the microstrip patch 231, parasitic capacitance (Cᵣ) of the ground plane, and conductance (Gₚ).

Here, the microstrip patch 231 may be in a resonance state in which the length of the microstrip patch 231 is adjusted to cancel susceptance, which is an imaginary part of admittance, and leave only conductance which is a real part thereof. Such a case may be represented by the equivalent circuit shown in FIG. 6.

Accordingly, by adjusting the length of the gap G, since the length of the microstrip patch 231 entering a resonance state is detected based on each gap G, in the present embodiment, the length of the microstrip patch 231 according to the gap G is detected as shown in Table 1.

TABLE 1

| Element Number [symbol] | Gap (Gᵢ) [symbol] | Length (Lᵢ) [symbol] |
|---|---|---|
| (i = 1-18) [symbol] | [mm] [symbol] | [mm] [symbol] |
| 1, 18 [symbol] | 0.155 [symbol] | 1.025 [symbol] |
| 2, 17 [symbol] | 0.155 [symbol] | 1.025 [symbol] |
| 3, 16 [symbol] | 0.151 [symbol] | 1.024 [symbol] |
| 4, 15 [symbol] | 0.142 [symbol] | 1.024 [symbol] |
| 5, 14 [symbol] | 0.128 [symbol] | 1.022 [symbol] |
| 6, 13 [symbol] | 0.116 [symbol] | 1.021 [symbol] |
| 7, 12 [symbol] | 0.107 [symbol] | 1.019 [symbol] |
| 8, 11 [symbol] | 0.102 [symbol] | 1.018 [symbol] |
| 9, 10 [symbol] | 0.100 [symbol] | 1.018 [symbol] |

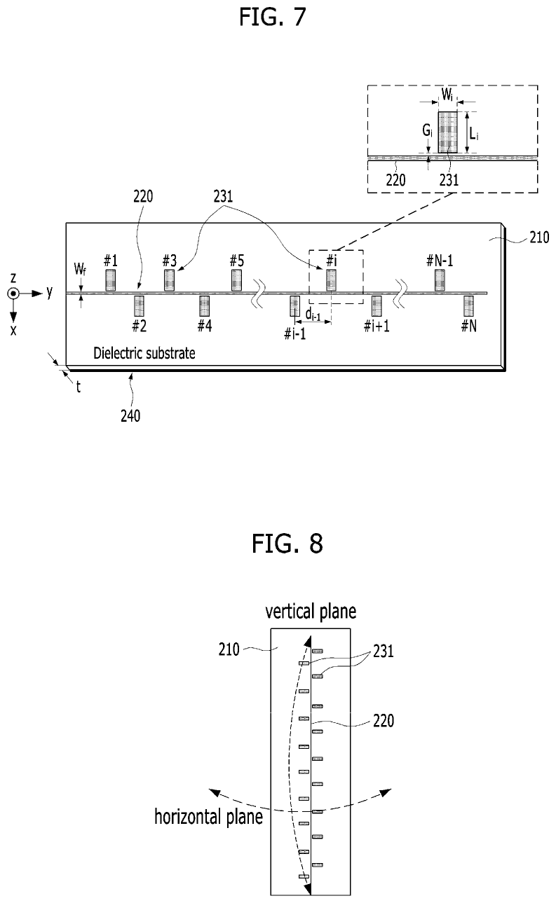

FIG. 7 illustrates a capacitively-coupled comb-line microstrip patch array antenna according to yet another embodiment of the present invention, which is designed to implement the same performance as a conventional capacitively-coupled comb-line microstrip patch array antenna.

In order to confirm the performance of the capacitively-coupled comb-line microstrip array antenna of yet another embodiment of the present invention, the capacitively-coupled comb-line microstrip array antenna of yet another embodiment of the present invention is designed to include the same number of a radiating element as the conventional capacitively-coupled comb-line microstrip patch array antenna.

In order to obtain the same performance, as shown in Table 1, a radiating element array module 230 was designed to have a gap G between 1×18 (first to eighteenth) capacitively-coupled comb-line microstrip patches and a length Li of the microstrip patch.

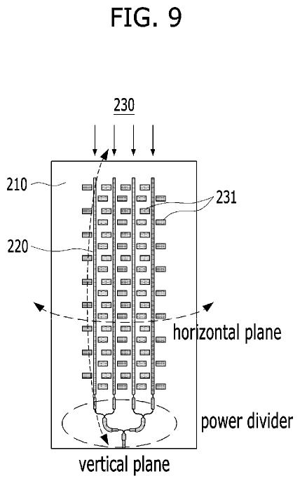

FIG. 8 illustrates a 1×18 capacitively-coupled comb-line microstrip patch designed using one radiating element array module 230 of a capacitively-coupled comb-line microstrip array antenna according to yet another embodiment of the present invention. FIG. 9 illustrates a 4×18 capacitively-coupled comb-line microstrip patch in which four radiating element array modules 230 of a capacitively-coupled comb-line microstrip are combined in parallel according to yet another embodiment of the present invention.

The 1×18 array antenna and the 4×18 array antenna have been designed to operate at a frequency of 79 GHz, and radiation conductance of each microstrip patch 231 has been designed to have a weighting distribution such that a side lobe level of a beam in a vertical direction of an antenna array direction is in a Taylor distribution of −20 dB.

An interval between the elements is a half-wavelength (λ_{g}/2) of a microstrip feed line 220, and an interval from the feed line 220 varies according to the weighting distribution.

Meanwhile, in the Taylor distribution, since radiation conductance is high at a center of an array and a radiation conductance value is gradually decreased toward both sides of the array, the interval (Gi) from the feed line 220 is designed to also be increased.

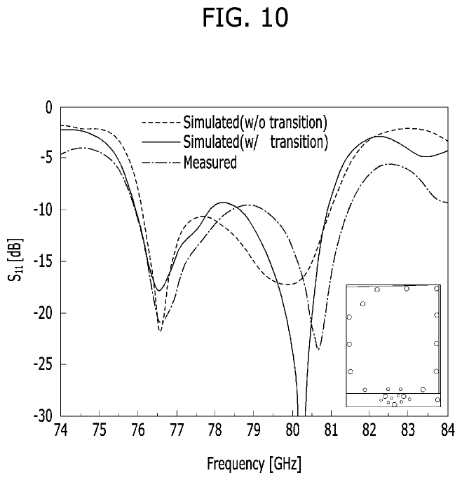

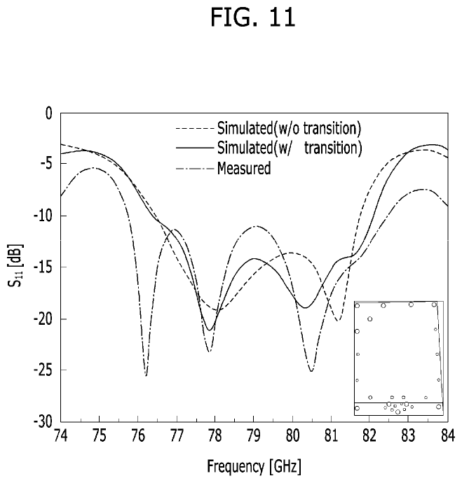

FIG. 10 is a graph showing a reflection coefficient of the 1×18 capacitively-coupled comb-line microstrip patch array antenna according to yet another embodiment of the present invention. FIG. 11 is a graph showing a reflection coefficient of the 4×18 capacitively-coupled comb-line microstrip patch array antenna according to yet another embodiment of the present invention.

As shown in FIGS. 10 and 11, it can be confirmed that simulated values and measurement values of the reflection coefficients of the capacitively-coupled comb-line microstrip patch array antennas according to yet another embodiment of the present invention are similar.

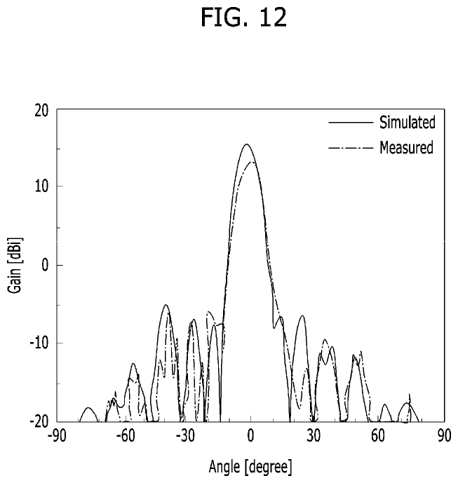

FIG. 12 shows simulated values and measurement values of a radiation pattern of the 1×18 capacitively-coupled comb-line microstrip patch array antenna and is a graph showing simulated values and measurement values of a radiation pattern on a vertical plane (y-z plane) at a frequency of 79 GHz.

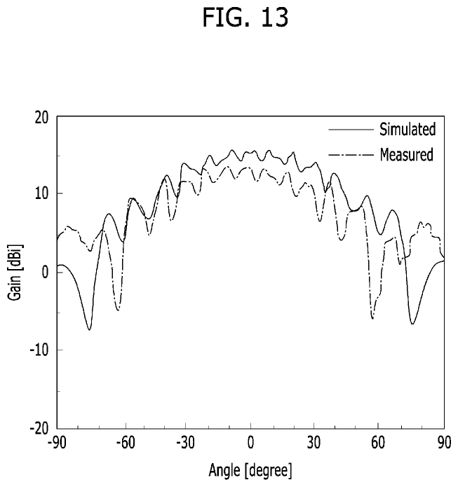

FIG. 13 shows simulated values and measurement values of a radiation pattern of the 1×18 capacitively-coupled comb-line microstrip patch array antenna and is a graph showing simulated values and measurement values of a radiation pattern on a horizontal plane (x-z plane) at a frequency of 79 GHz.

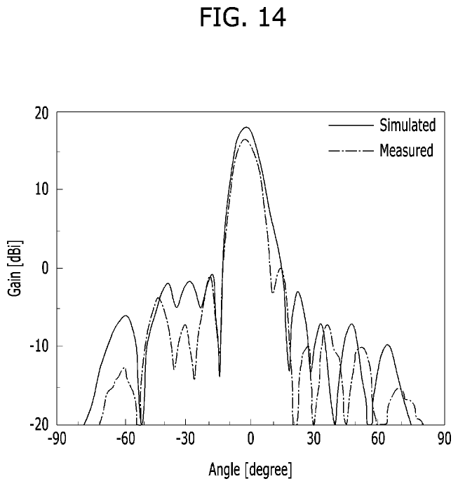

FIG. 14 shows simulated values and measurement values of a radiation pattern of the 4×18 capacitively-coupled comb-line microstrip patch array antenna and is a graph showing simulated values and measurement values of a radiation pattern on a vertical plane (y-z plane) at a frequency of 79 GHz.

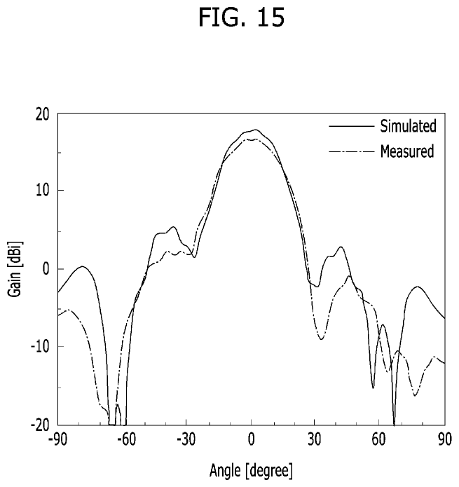

FIG. 15 shows simulated values and measurement values of a radiation pattern of the 4×18 capacitively-coupled comb-line microstrip patch array antenna and is a graph showing simulated values and measurement values of a radiation pattern on a horizontal plane (x-z plane) at a frequency of 79 GHz.

It can be confirmed that both the 1×8 capacitively-coupled comb-line microstrip patch array antenna and the 4×18 capacitively-coupled comb-line microstrip patch array antenna have a side lobe level of −20 dB or less on the vertical plane (y-z plane) and an antenna beam thereof at a frequency of 79 GHz faces in front of the antenna.

In the present embodiment, an example of the capacitively-coupled comb-line microstrip patch array antenna at a frequency of 79 GHz is described, but the same performance can be exhibited at frequencies of 79 GHz and 80 GHz.

According to one embodiment of the present invention, there is an effect of being able to provide a comb-line array antenna of a microstrip patch excited by capacitive coupling.

In the capacitively-coupled comb-line array antenna according to one embodiment of the present invention, the microstrip patches 231, which are thin and have the same width, are arrayed, but an interval from the feed line is adjusted to determine a radiation conductance value, and thus, an interval between elements is about half of that of a series-fed microstrip patch antenna. Accordingly, there is an effect of being able to design a small array.

In addition, in the case of a conventional comb-line microstrip patch antenna electrically connected to a microstrip feed line, since radiation conductance should be adjusted using a width of a microstrip patch which is a radiating element, radiation conductance of a center radiating element should be greater than that of an edge radiation element, resulting in an increase in width. Accordingly, it is difficult to design a beam having a desired side lobe level. However, according to the present invention, there is an effect of facilitating a beam design and solving a problem of occurrence of cross polarization.

In another embodiment of the present invention, the capacitively-coupled comb-line array antenna is designed by adjusting radiation conductance of the radiating element using an interval between the microstrip patch 231 and the feed line 220, thereby forming a desired beam.

Unlike a comb-line antenna in which the feed line 220 and the microstrip patch 231, which is a radiating element, are electrically connected, the antenna is a capacitively-coupled comb-line microstrip array antenna using a method of feeding the microstrip patch 231 through capacitive coupling.

Although configurations of the present invention have been described in detail above with reference to the accompanying drawings, these are mere examples, and those of ordinary skill in the technical field to which the present invention pertains can make various modifications and changes within the technical spirit of the present invention. Therefore, the scope of the present invention should not be limited to the above-described embodiments but should be determined by the appended claims.

What is claimed is:

1. A capacitively-coupled comb-line microstrip array antenna comprising:
a dielectric substrate;
a feed line formed on the dielectric substrate in a length direction thereof; and
microstrip patches vertically formed with a gap of a certain interval from the feed line.

2. The capacitively-coupled comb-line microstrip array antenna of claim 1, wherein the gap (G) between the feed line and the microstrip patch is determined according to a length of the microstrip patch in a resonance state.

3. A capacitively-coupled comb-line microstrip array antenna comprising:
a dielectric substrate;
a feed line formed on the dielectric substrate in a length direction thereof;
a radiating element array module formed by microstrip patches vertically formed with a gap (G) from the feed line being arranged at certain intervals at one side of the feed line; and
a ground plane formed on a lower surface of the dielectric substrate.

4. The capacitively-coupled comb-line microstrip array antenna of claim 3, wherein the microstrip patches have rectangular shapes having the same width.

5. The capacitively-coupled comb-line microstrip array antenna of claim 3, wherein an interval between the microstrip patches formed in the radiating element array module is a wavelength (λ_{g}) of the feed line.

6. The capacitively-coupled comb-line microstrip array antenna of claim 3, further comprising a radiating element array module formed by microstrip patches vertically formed with a certain distance from the feed line being arranged at certain intervals at the other side of the feed line.

7. The capacitively-coupled comb-line microstrip array antenna of claim 6, wherein the microstrip patch formed in the radiating element array module formed at one side of the feed line and the microstrip patch formed in the radiating element array module formed at the other side thereof are formed to include open stubs with the feed line interposed therebetween.

8. The capacitively-coupled comb-line microstrip array antenna of claim 7, wherein the interval between the microstrip patches formed in the radiating element array module is a half-wavelength (λ_{g}/2) of the feed line.

9. The capacitively-coupled comb-line microstrip array antenna of claim 8, wherein a length of the microstrip patch is determined by a length of the microstrip patch in a resonance state based on the gap (G) between the feed line and the microstrip patch.

10. The capacitively-coupled comb-line microstrip array antenna of claim 3, wherein a plurality of radiating element array modules identical to the radiating element array module are formed in parallel.

11. The capacitively-coupled comb-line microstrip array antenna of claim 1, wherein the gap (G) between the microstrip patch and the feed line corresponds to a weighting distribution.

12. The capacitively-coupled comb-line microstrip array antenna of claim 1, wherein a direction of a beam is adjusted by adjusting a phase excited in the microstrip patch which is each radiating element.
